(19) United States
(12) Patent Application Publication
(10) Pub. No.: US 2012/0242138 A1
(43) Pub. Date: Sep. 27, 2012

(54) Carbon Bodied Bicycle Rim with Reinforcement Layer

(76) Inventor: Wen-Feng Tsai, Taichung City (TW)

(21) Appl. No.: 13/053,561

(22) Filed: Mar. 22, 2011

(51) Int. Cl. B60B 21/00; B32B 38/00; B32B 37/14; B32B 37/06; B32B 37/10

(52) U.S. Cl. 301/95.103; 156/245

(57) ABSTRACT

According to the present invention, a bicycle rim comprises a rim body and a reinforcement layer. Each of the rim body and the reinforcement layer is constructed of carbon fiber, and the reinforcement layer is integrally formed on the rim body.

### BACKGROUND OF THE INVENTION

1. Field of the Invention

The present invention relates generally to a carbon bodied bicycle rim and, more particularly, to a carbon bodied bicycle rim having a reinforcement layer integrally formed thereon.

2. Description of the Related Art

U.S. Pat. No. 7,290,839 shows a bicycle rim which includes a tire attachment portion, a spoke attachment portion and a plurality of reinforcement members. The spoke attachment portion is fixedly coupled with the tire attachment portion. The spoke attachment portion includes a plurality of circumferentially spaced attachment openings. The reinforcement members are fixedly coupled to the spoke attachment portion at the attachment openings to effectively increase the thickness of the spoke attachment portion of the rim at the attachment openings. Each of the reinforcement members is bonded to the spoke attachment portion. The through openings are aligned with the attachment openings. The reinforcement members could be bonded to an attachment portion with adhesive or a cementing agent (e.g., other than metal), instead of a brazing/soldering metal, and forms an adhesive layer therebetween. There are problems that the bicycle rim weight increases, and the adhesive layer will deteriorate and lose connection with the reinforcement member and the spoke attachment portion or the rim after a long period of time.

The present invention is, therefore, intended to obviate or at least alleviate the problems encountered in the prior art.

### SUMMARY OF THE INVENTION

According to the present invention, the main purpose is to provide a bicycle which comprises a rim body and a reinforcement layer. Each of the rim body and the reinforcement layer is constructed of carbon fiber, and the reinforcement layer is integrally formed on the rim body.

An advantage of the bicycle rim according to the present invention is that an air bag is inflated and a mold is heated to cure the rim body and the reinforcement layer such that the reinforcement layer and the rim body would be steadily connected with each other and be formed in one piece.

Another advantage of the bicycle rim according to the present invention is that a third thickness is larger than a first thickness so that the bicycle rim has enough stiffness to provide adequate support, and prevent the deformation thereof.

A further advantage of the bicycle rim according to the present invention is that there is no adhesive layer between the rim body and the reinforcement layer so that the rim body would not lose connection with the reinforcement layer.

Other advantages and features of the present invention will become apparent from the following description referring to the drawings.

### BRIEF DESCRIPTION OF THE DRAWINGS

FIG. 1 is a flow chart of a method for producing a bicycle rim in accordance with the present invention.

FIG. 2 illustrates the bicycle rim of the present invention comprises a rim body and a reinforcement layer.

FIG. 3 shows that the reinforcement layer is stacked onto a fixing layer of the rim body.

FIG. 4 shows the rim body has a space formed between the fixing layer and a connecting layer.

FIG. 5 shows an air bag is inflated and a mold is heated to cure the fixing layer and the connecting layer.

FIG. 6 is a cross-sectional view of the bicycle rim and shows that a larger reinforcement unit is stacked on the smaller reinforcement unit.

FIG. 7 is a cross-sectional view of the bicycle rim and shows a third thickness is larger than a first thickness.

FIG. 8 is a continued cross-sectional view of FIG. 7 and shows the reinforcement layer is integrally formed on the rim body.

FIG. 9 is a cross-sectional view taken alone line 9-9 in FIG. 8.

FIG. 10 is a continued cross-sectional view of FIG. 8 and shows a hole extends from an abutted face of the reinforcement layer to an outer side of the fixing layer.

### DETAILED DESCRIPTION OF THE PREFERRED EMBODIMENT

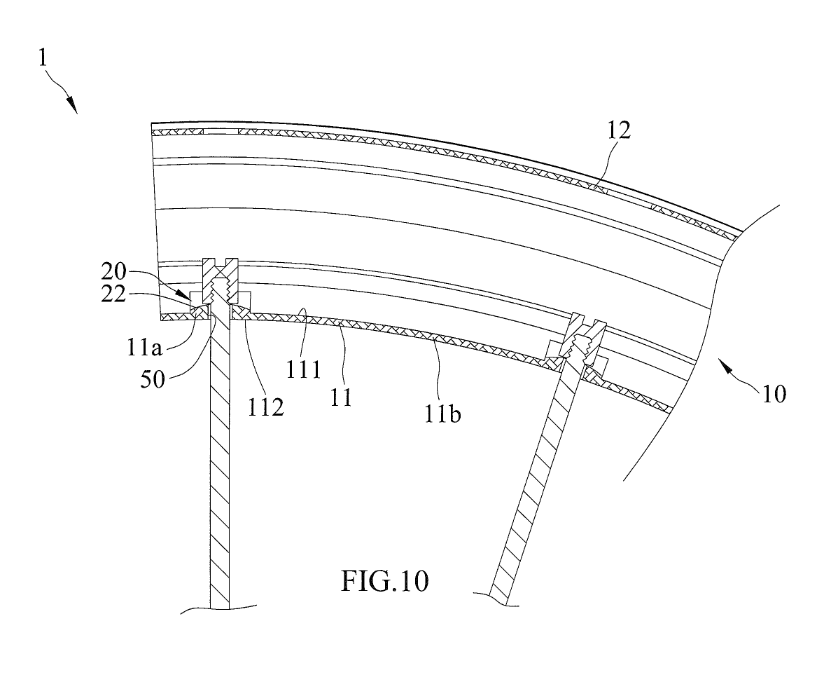

Referring to FIG. 10, there is shown a bicycle rim 1 according to the present invention. The bicycle rim 1, which is constructed of carbon fiber composite and is in form of one piece, comprises a rim body 10 and at least one reinforcement layer 20 provided on the rim body 10.

The rim body 10, which is constructed of carbon fiber, includes a fixing layer 11 and a connecting layer 12 for anchoring a tire (not shown). The fixing layer 11 has two sides including an inner side 111, and an outer side 112 opposite to the inner side 111. The inner side 111 has at least one first portion 11a on which the reinforcement layer 20 is integrally formed, and a second portion 11b with no reinforcement layer 20 attached to.

The reinforcement layer 20 is integrally formed on the first portion 11a of the inner side 111 of the fixing layer 11 and is protruded from the inner side 111 toward the connecting layer 12. The reinforcement layer 20 has an abutted face 22 defined thereon. Preferably, the bicycle rim 1 comprises at least one hole 50 for insertion of the spoke. The hole 50 extends from the abutted face 22 of related reinforcement layer 20 to the outer side 112 of the fixing layer 11. Preferably, the hole 50 extends from a middle portion of the abutted face 22 of related reinforcement layer 20 to the outer side 112 of the fixing layer 11 such that the bicycle rim 1 has enough stiffness to provide adequate support.

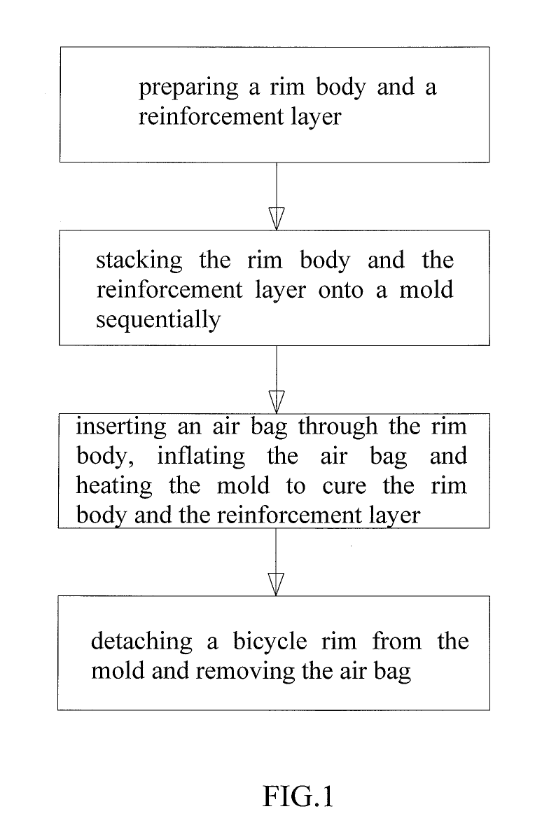

Referring to FIG. 1, a method for producing the bicycle rim 1 includes the steps of: (a) preparing the rim body 10 and the reinforcement layer 20; (b) stacking the rim body 10 and the reinforcement layer 20 onto a mold 30 sequentially; (c) inserting an air bag 40 through the rim body 10, inflating the air bag 40 and heating the mold 30 to cure the rim body 10 and the reinforcement layer 20; and (d) detaching the bicycle rim 1 from the mold 30 and removing the air bag 40.

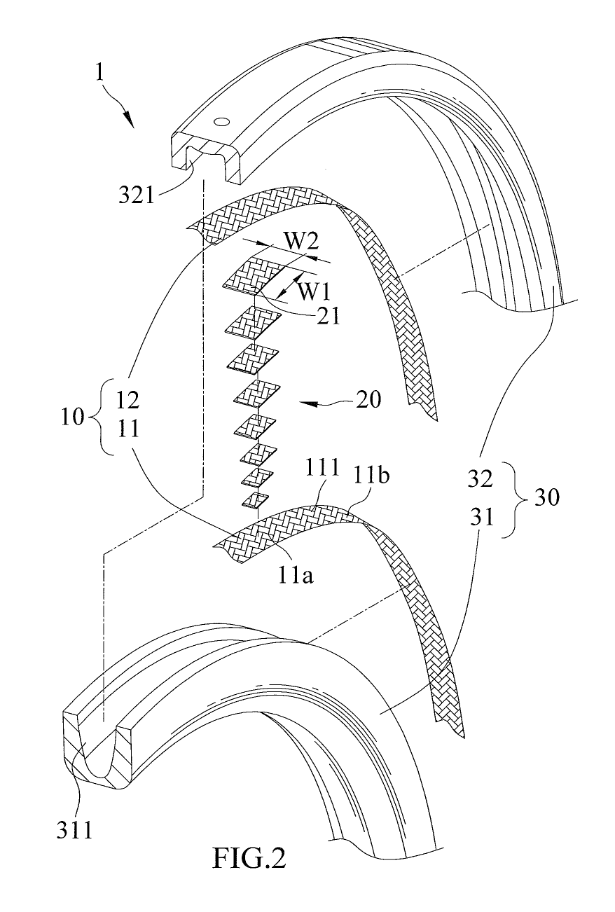

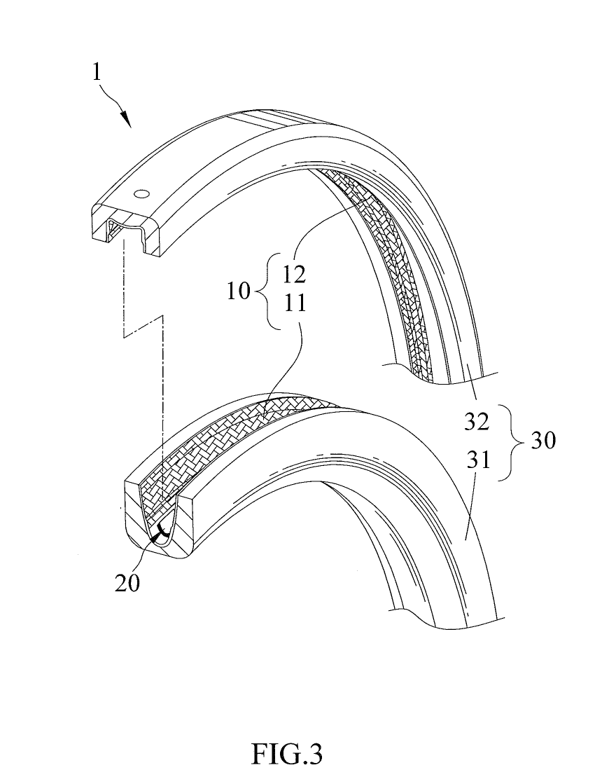

Referring to FIGS. 2 and 3, the reinforcement layer 20 includes a plurality of reinforcement units 21 which have different sizes with respect to each other. Specifically, the largest reinforcement unit 21 defines a length W1 and a width W2 in which the length W1 is larger than a diameter of the spokes and the width W2 is larger than the diameter of the spokes. The rim body 10 and the reinforcement layer 20 are sequentially stacked onto the mold 30 which includes an inner element 31 and an outer element 32. At first, the fixing layer 11 is disposed to a surface 311 of the inner element 31 of the mold 30, then the reinforcement layer 20 is disposed to the first portion 11a of the inner side 111 of the fixing layer 11. Preferably, each reinforcement unit 21 is sequentially stacked along a radial direction of the rim body 10 and the larger reinforcement unit 21 is stacked on the smaller reinforcement unit 21, so that a sliding of the reinforcement unit 21 is prevented while the rim body 10 and the reinforcement layer 20 is curing. The connecting layer 12 is disposed on a surface 321 of the outer element 32. Preferably, the bicycle rim 1 comprises a plurality of reinforcement layers 20 separately provided on the rim body 10 and each reinforcement layer 20 is spaced from each other and corresponds to related spoke. Each reinforcement layer 20 is integrally formed on the inner side 111 of the fixing layer 11.

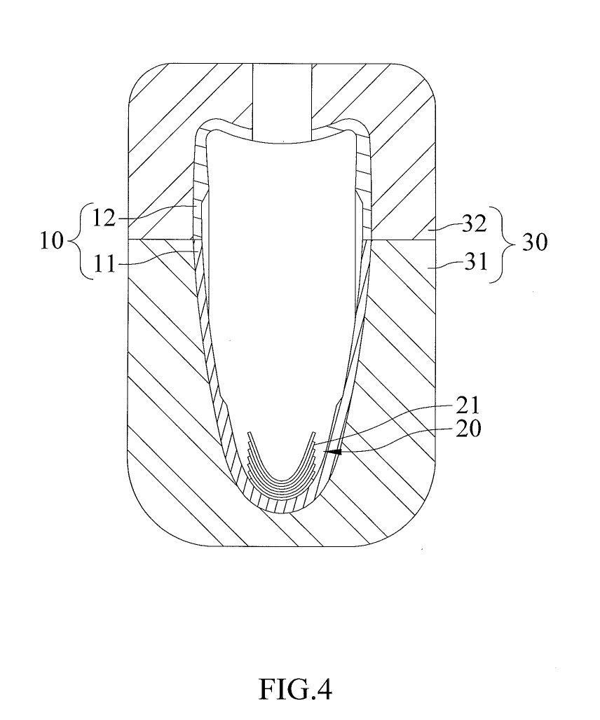

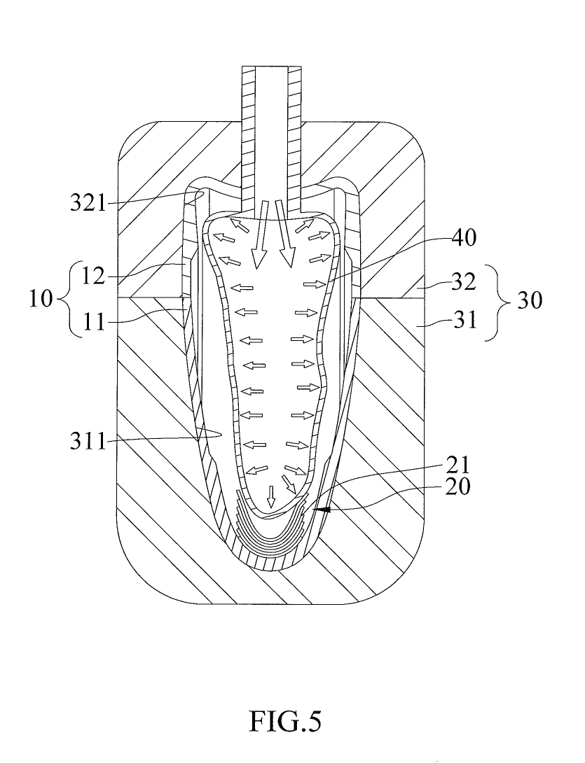

Referring to FIGS. 4 and 5, the rim body 10 has a space formed between the fixing layer 11 and the connecting layer 12 while the inner element 31 and the outer element 32 is combined with each other. An air bag 40 is inserted through the space of the rim body 10, then the air bag 40 is inflated and the mold 30 is heated to cure the rim body 10 and the reinforcement layer 20 such that the reinforcement layer 20 and the fixing layer 11 of the rim body 10 would be steadily connected with each other and be formed in one piece, and the fixing layer 11 and the connecting layer 12 would abut the surfaces 311, 321 of the inner element 31 and outer element 32, respectively.

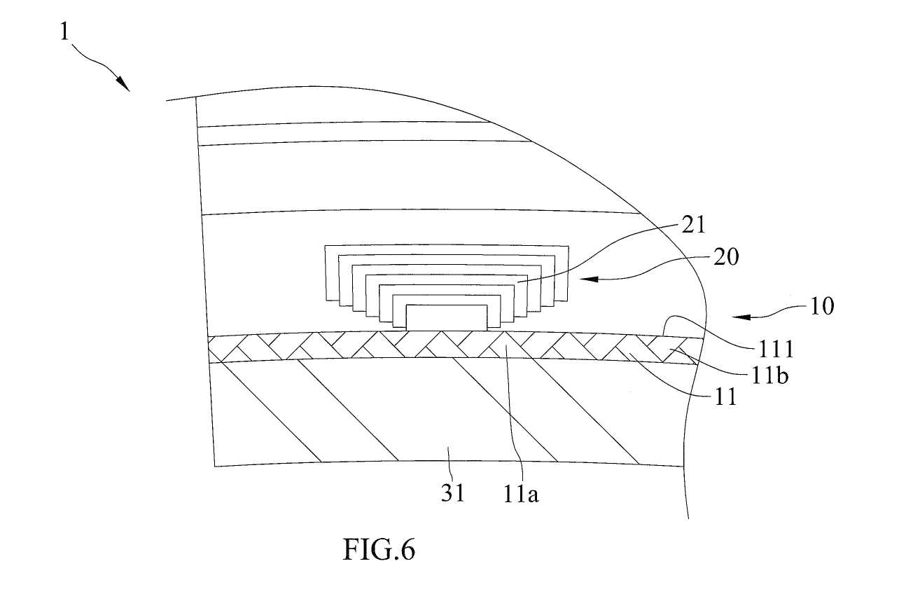

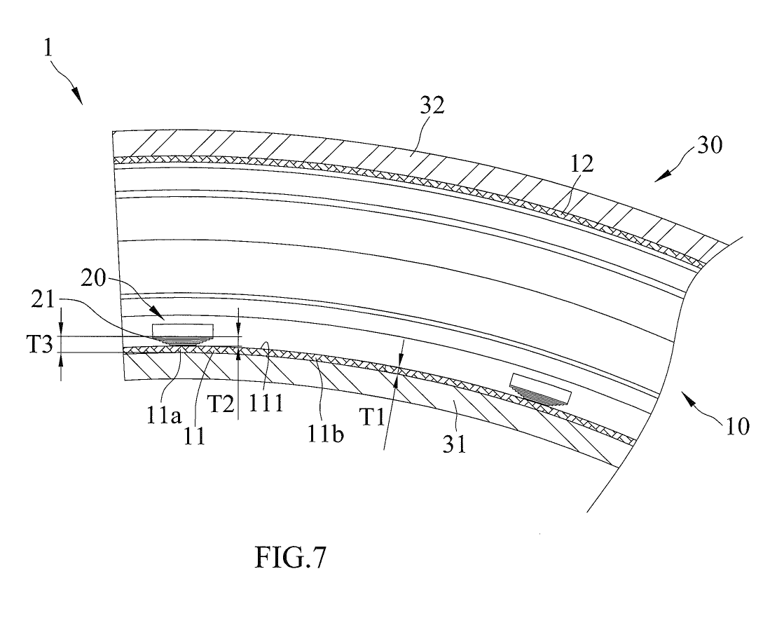

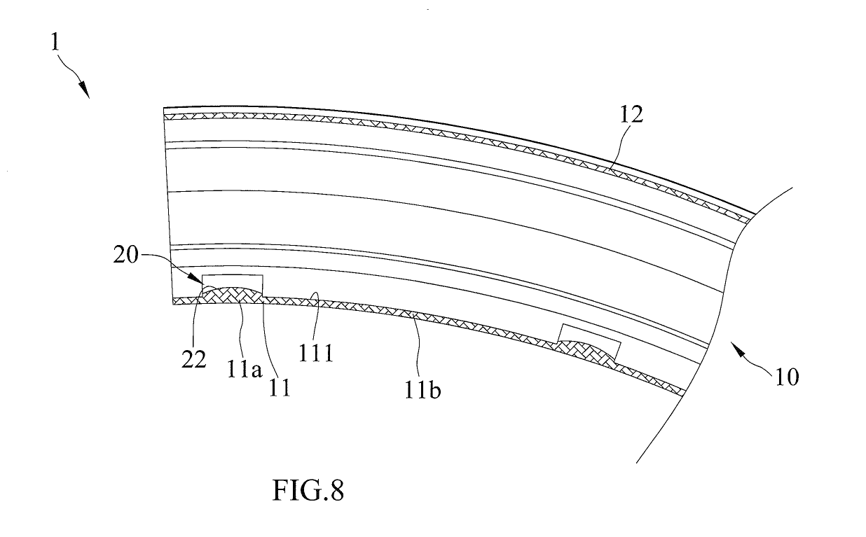

Referring to FIGS. 6 through 8, the rim body 10 has a first thickness T1 which is the thickness of the first portion 11a is the same with that of the second portion 11b and is the same with the first thickness T1. The reinforcement layer 20 has a second thickness T2. The bicycle rim 1 has a third thickness T3 defined between the abutted face 22 to the outer side 112 of the fixing layer 11. Preferably, the third thickness T3 is the sum of the first thickness T1 and the second thickness T2, so that the bicycle rim 1 has enough stiffness to provide adequate support, and prevent the deformation thereof.

The abutted face 22 is of a convex shape due to that the each reinforcement unit 21 is sequentially stacked along a radial direction of the rim body 10 and the larger reinforcement unit 21 is stacked on the smaller reinforcement unit 21. Therefore, the thickness of a middle portion of the reinforcement layer 20 is larger than that of the other portion of the reinforcement layer 20, and the abutted face 22 is smoothly connected to the inner side 111 of the fixing layer 11 such that the stress concentration is prevented.

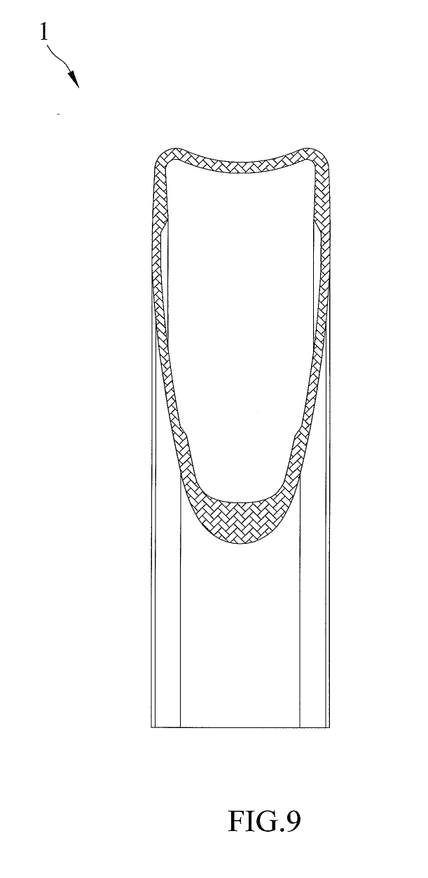

Referring to FIG. 9, the bicycle rim 1 is detached from the mole 30 and the air bag 40 is removed from the bicycle rim 1. The bicycle rim 1 is adapted for other heat processing or surface processing to match the requirement of the market. Further, the bicycle rim 1 is of a one piece, there is no adhesive layer between the rim body 10 and the reinforcement layer 20 so that the rim body 10 would not lose connection with the reinforcement layer 20. The reinforcement layer 20 is constructed of carbon fiber composite so as to decrease excess weight and enhance stiffness thereof.

The present invention has been described through the illustration of the embodiments. Those skilled in the art can derive variations from the embodiments without departing from the scope of the present invention. Hence, the embodiments shall not limit the scope of the present invention defined in the claims.

What is claimed is:

1. A bicycle rim comprising:
a rim body including a fixing layer, with the rim body constructed of carbon fiber; and
a reinforcement layer integrally formed on the fixing layer, with the reinforcement layer constructed of carbon fiber.

2. The bicycle rim as claimed in claim 1, with the fixing layer including an inner side on which the reinforcement layer is integrally formed.

3. The bicycle rim as claimed in claim 1 further comprising a plurality of reinforcement layers separately provided on the rim body, wherein each reinforcement layer is spaced from each other and corresponds to related spoke, with the fixing layer including an inner side on which the plurality of reinforcement layer is integrally formed.

4. The bicycle rim as claimed in claim 1, further comprising at least one hole for insertion of a spoke, wherein the reinforcement layer has an abutted face defined thereon, wherein the abutted face is of a convex shape, wherein a thickness of a middle portion of the reinforcement layer is larger than that of the other portion of the reinforcement layer, wherein the hole extends from the abutted face of the reinforcement layer to an outer side of the fixing layer.

5. The bicycle rim as claimed in claim 1, wherein the fixing layer includes an inner side and an outer side opposite to the inner side, wherein the inner side has at least one first portion on which the reinforcement layer is integrally formed, and a second portion, wherein the rim body has a first thickness, wherein the thickness of the first portion is the same with that of the second portion and is the same with the first thickness, wherein the reinforcement layer has a second thickness.

6. The bicycle rim as claimed in claim 5 further having a third thickness defined between an abutted face of the reinforcement layer to the outer side of the fixing layer, wherein the third thickness is the sum of the first thickness and the second thickness.

7. A method for producing a bicycle rim with reinforcement portion includes the steps of:
(a) preparing a rim body and a reinforcement layer;
(b) stacking the rim body and the reinforcement layer onto a mold sequentially;
(c) inserting an air bag through the rim body, inflating the air bag and heating the mold to cure the rim body and the reinforcement layer; and
(d) detaching the bicycle rim from the mold and removing the air bag.

8. The method for producing the bicycle rim as claimed in claim 7, wherein the rim body includes a fixing layer and a connecting layer, wherein the rim body and the reinforcement layer are sequentially stacked onto the mold which includes an inner element and an outer element, wherein the fixing layer is disposed to a surface of the inner element of the mold, then the reinforcement layer is disposed to an inner side of the fixing layer, wherein the connecting layer is disposed on a surface of the outer element.

9. The method for producing the bicycle rim as claimed in claim 8, wherein the reinforcement layer includes a plurality of reinforcement unit, wherein each reinforcement unit is sequentially stacked along a radial direction of the rim body.

10. The method for producing the bicycle rim as claimed in claim 8, wherein the reinforcement units have different sizes with respect to each other, wherein the larger reinforcement unit is stacked on the smaller reinforcement unit.
